(19) United States
(12) Patent Application Publication
(10) Pub. No.: US 2008/0059210 A1
(43) Pub. Date: Mar. 6, 2008

(54) CompuSpections state inspection record / reports software

(76) Inventors: Bernard Laverne Elder, Butler, PA (US); Anita Louise Ziemba, Eighty Four, PA (US)

Correspondence Address: Anita L. Ziemba, 222 Roberts Road, Eighty Four, PA, 15330, US

(21) Appl. No.: 11/511,928

(22) Filed: Aug. 29, 2006

(51) Int. Cl. G06Q 50/00

(52) U.S. Cl. 705/1

(57) ABSTRACT

A computer based safety inspection record keeping and reporting system. It can be used a a replacement, or in addition to a cumbersome paper-based system. The system allows the user to create a work order, record the required safety inspection information on the work order. The user can then transfer the information to the safety inspection record and assign the next sequential safety inspection certificate. Extensive error checking of required data is performed on the work order during data entry and also before the transfer to insure the accuracy and completeness of the safety inspection record. A safety inspection certificate is not issued until the required information is recorded. It also insures that safety inspection certificates are issued in sequence. The safety inspection record stores all required information and can be used to generate the paper copy of the form.

### APPLICATION DESCRIPTION

The application uses a relational data base management program (Delphi) that takes input data and creates a state required report for vehicle state safety inspection results. This application can be adapted to any state's/province's/country's reporting requirements.

### BACKGROUND

Many states require periodic safety inspection for vehicles registered in their states. These include cars, trucks, motorcycles and trailers. Items checked include brakes, tire depth, lights, suspension, supplement restraints, etc. The results of these inspections must be manually documented on state required forms. This is a time consuming task and is subject to frequent errors. (See Exhibit A—Pennsylvania Sample)

Many states also have a staff of inspectors/auditors who evaluate the state safety inspection procedures at establishments that perform safety inspections. Besides evaluating safety inspection procedures, they also examine the records used to document the results of these inspections. If the proper procedures are not followed or the records are incomplete or incorrect, the station could be fined for deficiencies, including those in the records.

Most repair shops have some kind of work order/invoice system. It may be handwritten or a software system designed specifically for a repair shop or body shop. When a repair shop is certified to perform vehicle safety inspections, it must also record information about each safety inspection performed usually handwritten on state required forms. In some states, the work order generated for a safety inspection has specific requirements for information to be recorded on the work order. In many cases, the existing work order/invoice system does not include the ability to record everything required of a safety inspection as it was not designed for that purpose.

The work order generated in the SIR system was designed specifically to include safety inspection record keeping requirements and can be a supplement to an existing work order/invoice system so the station can comply with state requirements for the safety inspection record keeping process.

### Problems Encountered By Safety Inspection Stations Recording Results Of Safety Inspections

Legibility is a constant problem. This problem arises when station personnel try to write too fast, or have poor penmanship.

Accuracy and completeness can be compromised if erroneous entries are made, or entries are missing. In order to properly complete the inspection process, the results must be entered, handwritten, on state required forms.

Difficulty of retrieval is a problem as station personnel often don't have systems in place to retrieve documents easily, especially work orders, which are critical to the process (more discussion of work orders below).

Poor documentation is a problem when a station uses informal forms to document inspection results. These forms later become detached form the rest of the paperwork, and are often lost or discarded.

Time required to inspect the records of these inspections, by the state inspectors, increases as the accuracy, legibility and completeness decreases. Inspectors have many stations to audit, and good records facilitate their audit process.

### The State Inspection Process

A customer supplies the inspection station with a vehicle registration card, and proof of insurance, at the time the vehicle is brought in for inspection. The vehicle registration and insurance must be current at the time of the vehicle safety inspection.

A work order is then prepared, which requires handwriting of customer name, address, vehicle identification number (VIN), make, model, mileage and license plate number and insurance information. (Exhibit B)

The safety inspection is performed and the results are recorded on the work order. If there is a safety item needing repair or replacement, this must be done before the vehicle can pass the inspection and the work done so noted on the work order.

When the vehicle passes inspection, the station presents an invoice for the charges, and gives the customer a copy. In some states, the station is also required to give the customer a signed copy of the work order, with the inspection results, plus noting any items that were close to minimum requirements for that item and any items that may need attention before the next inspection is due.

The station must then complete the state required form, re-entering customer, vehicle, and insurance information already entered on the work order. The results of the inspection are also entered on the form. (Items that were Adjusted, Repaired or installed as New)

### Scope of Time Required For Processing Data

Inspection volume varies greatly. but can run as high as 15,000 to 30,000 annually in a single location. All of the records for these inspections are completed manually. If one inspection requires 6 minutes of time to complete the record, with 15,000 annually, the total time required would be 1500 hours per year. In comparison, the SIR application can complete this work in approximately 250 hours. If the customer returns for their next inspection of the same vehicle, all the manual entries can be extracted from the previous inspection. (Ex. Current mileage from the last inspection can be brought forward as the old mileage for the next inspection.)

### HOW THE APPLICATIONS WORKS

The system simulates the real world. It provides a work order for the technician to record safety inspection information and repairs with dollar amounts for items repaired to allow the vehicle to pass the safety inspection. When the work order information is entered into the system, the technician can then create a safety inspection record on the state required form. This will release a inspection sticker certificate number to the technician for the vehicle. Strict checking of the information on the work order is performed before an entry is placed in the state required form and a sticker is released. If any required information is missing, or items recorded are not within the required specifications for safety, (tires, brakes), a sticker is not released. Information checked also includes: insurance expiration dates and registration expiration date. (if the customer/vehicle information was scanned into the system) Warnings are displayed for various items (non-numeric entry for old odometer if the car is NEW, UNKNOWN, or OUT-OF-STATE.)

Items required are color coded to make it easy for the technician to know that all required information has been entered. Required information may vary based on the type of safety inspection. For example: A normal safety inspection may not require that the vehicle's old sticker number be included. However, a sticker being issued for a Windshield Replacement does require that the old sticker number be recorded but may not require the brake or tire entries.

The application processes this data in several simple steps. There is a scroll bar with eight buttons on the right side of the screen. Each button represents one of eight panels of information allowing easy navigation from one to the other. The user can navigate through the panels via the scrollbar, buttons, and/or keyboard. After the customer has presented their registration card and proof of insurance, the user can enter information from these documents to create the work order for the creation of a safety inspection record. The user moves through the panels as follows:

Customer Panel (Exhibit C 1/9) The bar code on the owner registration card is scanned, allowing instantaneous entry of customer name. street address. city, state, and zip code. Where applicable, the county is also entered via scan. The user work order number for cross reference to another invoicing system can also be entered here.

Vehicle Panel (Exhibit C 2/9) Information already scanned and entered includes: the Vehicle Identification Number (VIN), the license number, year of the car, make of the car and body type. The old odometer mileage and the current odometer reading are entered via keyboard.

The insurance company is entered via a drop down list, and policy number and expiration date are entered via keyboard. The insurance expiration date defaults to the computer's previous date to insure that the technician doesn't skip this required entry.

For a SELF-INSURED, PERMANENT or BINDER of insurance, where a date is not available, a field “EXPIRATION TEXT” is provided to allow the technician to override the date requirement and store and display this information instead. The “EXPIRATION TEXT” field also contains logic to review on entry and only accept valid information. This type of logic exists behind most of the data entry fields.

At this point, a work order is printed out, for the mechanic to record the work done on the car and the inspection results. (See Exhibit C 3/9)

Labor Panel (Exhibit C 4/9) This is used to show the labor charges for the state inspection, and also allows for entering labor charges for other work done.

Parts Panel (Exhibit C 5/9) This is similar to the Labor Panel, but records parts sold.

Invoice Panel (Exhibit C 6/9) This panel totals the charges on an invoice. In some cases, there are two different amounts, one for parts and labor for inspection related work, and one for the total of all work done. The two are different when non-inspection work, such as an oil change, are included in the work done.

NOTE: Many inspection stations use invoices created in other software packages. In these cases, they could bypass the Labor, Parts and Invoice Panels in the SIR application. To provide cross referencing from SIR to their invoicing system, the user enters the other system's work order number in the block labeled User Work Order on the Customer Panel (See Ex. C. 1/9).

Inspection Panel (Exhibit C 7/9) This is where the specific inspection item results are input. The format of this panel mirrors the work order where the results were recorded. If information was scanned in from the vehicle registration card, the registration expiration date is picked up. (if available) If the registration card is expired, the item is marked accordingly.

Brakes Panel (Exhibit C 8/9) This panel allows for input of tire depth and brake measurements, as well as readings for brake drums and rotors, and suspension measurements.

Sticker Panel Exhibit C 9/9) The technician/mechanic ID, and expiration date of the new sticker is recorded, and a SIR record is created. If some data is incorrect, or does not meet the state specifications, the application will not allow this process to complete. These items need to be corrected before a sticker can be issued. If all the data is correct, and meets specifications, the SIR record will be created, and the next sticker number to be used will appear on this screen. The mechanic will then obtain the actual sticker, corresponding to the number in the SIR record, and affix it to the customer's windshield.

In some states, the technician fills in station identification information, inspection date, VIN, etc., and signs the back of the sticker. This screen will display the information that would be on the back of the sticker to help the technician fill out the sticker correctly. The steps to enter the data for an inspection usually can be done in about one minute. versus six to nine minutes for manual entry.

### APPLICATION FEATURES AND BENEFITS

The main feature of this application is the computer generated state inspection form. The tedious task of manually recording this information is no longer required. These reports are created from a print report command on the computer. (Exhibit D)

Another main feature is the ability to scan the bar codes on owner registration cards. This allows immediate entry of eleven fields required by most states. The time savings are significant.

The user cannot enter erroneous data, results that don't meet state specifications, or forget any data in the record. The application will prevent the record's completion if any of these situations occur.

Another significant feature is the ability to recall customer and vehicle data from memory when the customer returns for the next inspection. The info does not even need to be scanned. This is also a major time savings feature. For repeat customers, this customer and vehicle data is handwritten on the work order and the state inspection record each time the customer has an inspection done.

Other features include:
This application can be used on a standalone computer or on a network. If an inspection facility has 10 repair bays, with each having input terminals. they could use a network, allowing each to enter their inspections results independently into a centralized database;
Ease of retrieval of data is possible by use of the Search function. There are 19 fields that data can be searched and retrieved quickly. The Search function button is on the Customer Panel (EX. C 1/9);
For file safety purposes, several backup options are available. A manual backup and an automatic backup capability is included in the application. This will back up the entire data set to whatever location the user specifies: hard drive, network drive, floppy drive, memory stick, or jump drive. The automatic backup allows the user to designate when a backup should be performed. (Ex. Upon exit of the program, after a page of 10 records has been entered, or after a designated number of records has been entered.) The backup data sets are named based on the date and a sequence number, allowing for multiple backups per day. A cleanup program is also included to allow the user to designate when to purge the backup data sets based on how many days worth of backups, that should be kept. (up to 99 days);
This application is adaptable to any state that requires reporting of results for vehicle safety inspections. The procedures and data collected are very similar from state to state. In many cases, the only difference between states is the format of the form;
The SIR application does not collect data for emissions inspections, but it does allow easy cross referencing to the inspection receipt numbers. The user could enter the emission inspection sticker number in the space provided on the Inspection Panel (EX. C, 9/9);
The application has the ability to transmit data to remote locations and for import into other applications. The current supports formats are comma separated (CSV) and XML 2.0;
Reports/forms provided in the system: State required form, Blank work order, Work order—for the technician to fill in the inspection information, Completed work order—displays the technician entries including the sticker information when a sticker is successfully released;
Additional SIR Reports—these can vary from state to state but the most popular reports include lists for: VOID stickers, Windshield Replacement, Re-issued, and Reconstructed Vehicles. A Failed Vehicle report is also included as some states require a separate form for Failed Vehicles. (A failed vehicle is one that failed the safety inspection for some reason.) Some other reports include Auditor counts for specific inspection criteria based on counties and regions. Other reports check that dollar amounts are entered for items marked as repaired or items are marked as repaired if dollar amounts are entered.

### SUMMARY

| | |
|---|---|
| Work Order | State Form |

| Data Item | Current | SIR | Current | SIR |
|---|---|---|---|---|
| Customer name, | Manual | Scanned | Manual | Scanned |
| address, city, | | | | |
| state, zip, county | | | | |
| Vehicle ID | Manual | Scanned | Manual | Scanned |
| number (17 | | | | |
| characters) | | | | |
| Vehicle make, | Manual | Scanned | Manual | Scanned |
| model | | | | |
| Vehicle Gross | Manual | Scanned | Manual | Scanned |
| Weight | | | | |
| Vehicle | Manual | Scanned | Manual | Scanned |
| Title Number | | | | |
| License | Manual | Scanned | Manual | Scanned |
| Number | | | | |
| County | Manual | Scanned | Manual | Scanned |
| Registration | Manual | Scanned | Manual | Scanned |
| Expiration Date | | | | |
| Inspection | Manual | Manual | Manual | Automatic |
| Results | | | | |
| State | n/a | n/a | Manual | Automatic |
| Form/Report | | | | |

### APPENDICES

1. Installation And Quick Start Guide
2. User Manual (As of July, 2004 does not reflect all the features embodied in the attached CD (EX. E)
3. Cheat Sheets
4. List of utilities/supporting programs
5. Sir Reports
6. List of files/folders on the source CD

### OTHER EXHIBITS

E—Application Flow Charts
F—SIR demo disks (2)
G—SIR program source disks (2)

We claim:

1. A software application for managing that facilitates accurate and error-free recording of required safety inspection information.

2. Method of managing Inspection Certificates (Stickers) through recording certificate receipt information and automatically issuing certificates in sequence.

3. Electronic Safety Inspection Record forms are stored on the computer with supporting work orders for each Inspection Certificate and are easily retrieved and printed for audits or investigations.

4. Helps protect stations owners from mistakes or misdeeds of some less than honorable/competent technicians.

5. Eliminates handwriting errors, sequencing errors, insurance date errors, measurement documentation errors caused by confusing rules & regulations.

6. Mistake free documentation, elimination of Sticker Management Headaches & uniform regulation interpretation.

7. Makes auditing of the station's records go much smoother and more quickly which means the QAO spends much less time in the facility tying up technicians and/or service managers.

8. Auditing a very large dealership could be cut to mere minutes which will allow for a more in-depth audit.

9. Organizes and centralizes safety inspection records for the smaller shops.

10. Method of tracking Emission Inspection Certificates (Stickers) through recording certificate issuing in the work order.

11. Creates legible, accurate, uniform and consistent Safety Inspection Documentation.

12. Use state of the art electronic scanning techniques to Eliminate human errors, Save time, Reduce expenses, Increase Productivity, & Simplify QAO Audits.

13. Designed by Certified Inspection Technicians for use by Certified Inspection Technicians

14. Enhance station revenue through use of collected inspection data.
